(19) United States
(12) Patent Application Publication
(10) Pub. No.: US 2002/0105571 A1
(43) Pub. Date: Aug. 8, 2002

(54) Ink-jet printer arrangement for printing both sides of a web

(76) Inventors: Hideo Izawa, Sakura-shi (JP); Takao Namiki, Sakura-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/058,729

(22) Filed: Jan. 30, 2002

(30) Foreign Application Priority Data
Feb. 8, 2001 (JP) P2001-31727

(51) Int. Cl. B41J 2/01

(52) U.S. Cl. 347/104

(57) ABSTRACT

An apparatus for printing both sides of a web by two sets of ink-jet printers. A first set of printers are aligned horizontally, and so are the second set, with a vertical spacing from the first set. Paid out from its roll, the web is first fed forwardly past the first set of ink-jet printers thereby to be printed on one side thereof, then reversely past the second set thereby to be printed on the other side. The web can be guided solely by parallel rollers without use of turning bars.

### BACKGROUND OF THE INVENTION

This invention relates to an apparatus for printing both sides of a web of paper or like printable material, and particularly to such a double-side printing apparatus employing an ink-jet printer or printers for printing each side of the web.

### DESCRIPTION OF THE PRIOR ART

Ink-jet printers by reason of their very construction presuppose use with their printing heads oriented downwardly. This operational requirement peculiar to ink-jet printers has imposed limitations upon their arrangement in use for printing both sides of a web. The opposite sides of the web are not printable concurrently, but only one after the other.

Japanese Unexamined Patent Publication No. 8-216467 suggests an arrangement in which a set of, four for instance, ink-jet printers are aligned in the traveling direction of the web, and another such set in side-by-side relationship to the first recited set. All the printers have their printing heads oriented downwardly. The web is first guided past the first set of printers thereby to have one side thereof printed, and then turned aside and back past the second set of printers thereby to have the other side printed. This conventional side-by-side arrangement of the two sets of ink-jet printers offers the advantage of reduction in the dimension of the apparatus in the traveling direction of the web from the supply station to the delivery station.

Offsetting this advantage of the prior art is the use of turning bars for turning aside and reversing the web from one set of ink-jet printers to the other. The web when traveling over the turning bars is particularly prone to the frictional development of static electricity, as well as lateral displacement or meandering. Another objection is that, arranged side by side, the two sets of ink-jet printers adds to the transverse, or one horizontal, dimension of the apparatus. The greater transverse, rather than vertical, dimension is undesirable because it is tantamount to a greater floor requirement of the apparatus.

### SUMMARY OF THE INVENTION

The present invention aims, in a double-side printing apparatus of the kind defined, at elimination of turning bars, and making do with parallel guide rollers only, in guiding the web from one printing means, such as an ink-jet printer or set of such printers, to another.

Another object of the invention is to reduce the lateral dimension, and therefore floor requirement, of the double-side printing apparatus to a minimum.

Still another object of the invention is to dry the printings on the web surfaces immediately after they have been made, with the drying means compactly arranged so as not to add to the floor requirement of the apparatus.

Summarized in its perhaps broadest aspect, the invention concerns a double-side printing apparatus comprising first printing means for printing one side of the web, and second printing means for printing the other side of the web. The first and the second printing means are spaced from, and in register with, each other in a prescribed direction. Also included are guide means for guiding the web past the first and the second printing means one after the other.

In the preferred embodiment of the invention to be herein disclosed, the first and the second printing means each take the form of a series of ink-jet printers. Both series of ink-jet printers extend horizontally, with a vertical spacing therebetween, and with their printing heads all directed downwardly. The web is first threaded forwardly (i.e. from infeed toward delivery) past one series of ink-jet printers, then reversed to travel backwardly past the other series of ink-jet printers, and then reversed again to travel toward the delivery.

Thus the web can have its opposite sides printed while traveling along a path that is contained in one vertical plane. No turning bars are needed, but only parallel rollers suffice, for such threading of the web past the two vertically spaced series of printers. The web is therefore not to produce static electricity by frictionally traveling over turning bars and so prevented from attracting the fine dust particles that invariably load the printing plant air.

Furthermore, as the two series of ink-jet printers are arranged one over the other, the apparatus according to the invention is materially reduced in lateral dimension compared with the prior art in which the two series were in side-by-side arrangement. Although somewhat increased in height, a factor that causes little or no inconvenience, the apparatus according to the invention gains a far more pronounced advantage of occupying significantly less floor area.

The dispensation with turning bars, made possible by this invention, leads to a simpler, more streamlined path of the web. As a consequence, not only is the apparatus simplified in construction, but the images printed by the respective ink-jet printers are bound to achieve a higher degree of registration.

A further feature of the invention resides in means for drying the printings made on both sides of the web. In the preferred embodiment the drying means take the form of drums around which the web is guided. Each disposed downstream of one series of ink-jet printers, and both inconspicuously positioned under the two series of ink-jet printers, the drum driers are well calculated to keep the space requirement of the apparatus at a minimum.

The above and other objects, features and advantages of this invention will become more apparent, and the invention itself will best be understood, from a study of the following description and appended claims, with reference had to the attached drawings showing the preferred embodiment of the invention.

### BRIEF DESCRIPTION OF THE DRAWINGS

FIG. 1 is a schematic side elevation of the double-side printing apparatus constructed in accordance with the novel concepts of this invention; and

FIG. 2 is a schematic top plan of the double-side printing apparatus of FIG. 1.

### DESCRIPTION OF THE PREFERRED EMBODIMENT

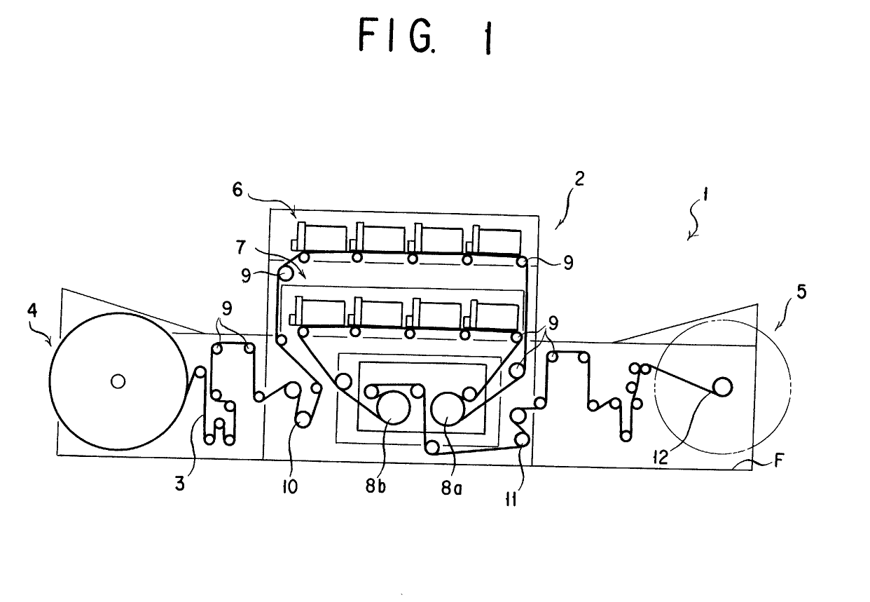

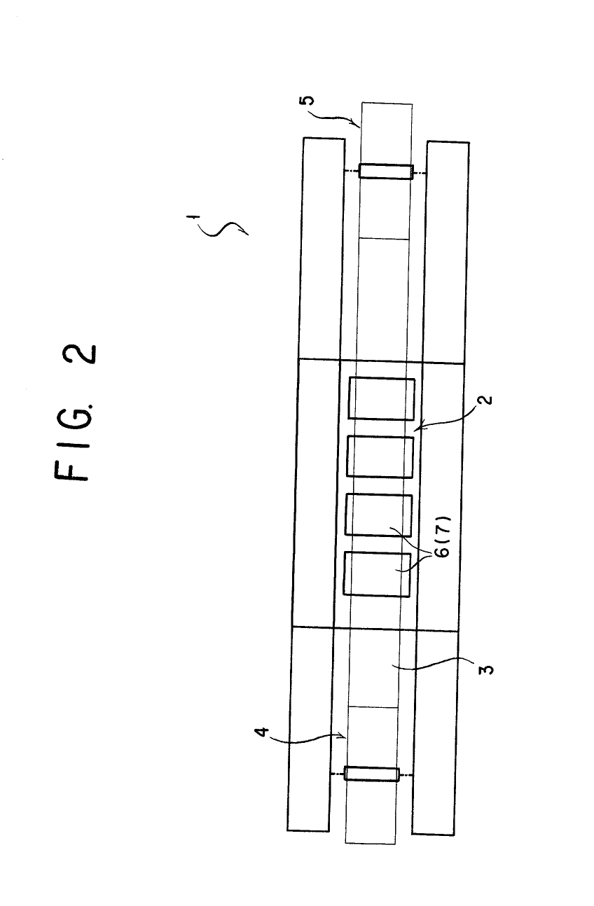

The present invention will now be described more specifically as embodied in the double-side printing apparatus shown in both FIGS. 1 and 2 of the attached drawings and therein generally designated 1. The apparatus 1 has a double-side printing station 2 through which a web 3 of paper travels on its way from an infeed station 4 to a delivery station 5. Hereinafter in this specification the directional terms such as “forward” and “backward” or “reverse” as well as derivatives thereof will be used in reference to the traveling direction of the web 3 from infeed station 4 to delivery station 5; that is, the web travels forwardly from infeed station to delivery station, and backwardly or reversely the other way around. Further the directional terms “horizontal” and “vertical” as well as derivatives thereof will be used with the understanding that the apparatus 1 is laid on the floor F, which of course is horizontal.

At the double-side printing station 2 there are provided a set of, four for example, ink-jet printers 6 and another such set of ink-jet printers 7 for printing the opposite sides of the web 3. The first set of ink-jet printers 6 are aligned horizontally in a vertical plane containing the infeed station 4 and the delivery station 5. Spaced downwardly from the first set of ink-jet printers 6, the second set of ink-jet printers 7 are similarly aligned horizontally in the same vertical plane therewith. The two sets of ink-jet printers 6 and 7 are all oriented downwardly. It is understood that the positions of all the ink-jet printers 6 and 7 are conventionally independently adjustable both longitudinally and transversely of the web 3. As is also conventional in the art, an optical sensor, not shown, may be provided for automatically setting the ink-jet printers 6 and 7 into operation upon sensing a marking on the web, although the printers may be more conventionally controlled.

Also provided at the printing station 2 are a first drum drier 8a for drying the printings made on one side of the web 3 by the first set of ink-jet printers 6, and a second drum drier 8b for drying the printings made on the other side of the web by the second set of ink-jet printers 7. Both drum driers 8a and 8b are compactly disposed under the ink-jet printers 6 and 7, occupying the same position transversely of the web 3.

For guiding the web 3 from infeed station 4 to delivery station 5 through the printing station 2, a series of guide rollers 9 are strategically arranged at points of vantage, all extending parallel to each other. At the printing station 2 the web 3 is guided by the guide rollers 9 to travel first forwardly under the first set of ink-jet printers 6, then down and around the first drum drier 8a, then up and backwardly under the second set of ink-jet printers 7, then down and around the second drum drier 8b, and then under the first drum drier 8a toward the delivery station 5. Seen at 10 and 11 are drawing rollers laid parallel to the guide rollers 9. The first drawing roller 10 is situated adjacent the entrance, and the second drawing roller 11 adjacent the exit, of the printing station 2, although these drawing rollers could be disposed respectively at the infeed station 4 and the delivery station 5. The drum driers 8a and 8b could also be provided outside the printing station 2.

The operation of the double-side printing apparatus 1 of the foregoing construction will be set forth hereinbelow on the assumption that the web 3 is unwound from its roll with its rear side directed upwardly as pictured in FIG. 1. The web 3 is to travel throughout the printing station 2 under a prescribed degree of tension imposed by the drawing rollers 10 and 11. First, going forwardly under the first set of ink-jet printers 6 with its rear side upward, the web 3 will be thereby printed on this rear side. Then the web 3 will be directed downwardly and travel around the first drum drier 8a, which is in rotation, with its front side held against the same. The printings made on the rear side of the web 3 by the first set of ink-jet printers 6 will therefore be dried without the danger of being rubbed against the first drum drier 8a and thereby smeared.

Then, going upwardly from the first drum drier 8a, the web 3 will travel reversely under the second set of ink-jet printers 7, this time with its front side upward, so that this front side of the web will be printed. Then the web 3 will be guided downwardly and around the second drum drier 8b. It is now the rear side of the web that will come into contact with the second drum drier 8b, so that the printings on its front side will be dried without being stained.

After being dried, the web 3 will travel forwardly toward the delivery station 5 by being pulled by the second drawing roller 11. The delivery station 5 is herein shown to have a takeup reel 12 for winding up the printed web 3.

It is now apparent that the various stated objects of this invention have been fully accomplished by the representative embodiment of the invention set forth above. A variety of modifications or alterations of the illustrated embodiment will nevertheless occur to the specialists within the broad teaching hereof. For instance, in each set of ink-jet printers 6 or 7, two or more printers may be aligned transversely of the web as required by the width of the printings to be made. It is therefore appropriate that the invention be construed broadly and in a manner consistent with the fair meaning or proper scope of the subjoined claims.

What is claimed is:

1. A double-side printing apparatus capable of printing both sides of a web of paper or like printable material, comprising:
(a) infeed means for supplying a web of paper or the like to be printed;
(b) first printing means for printing a first side of the web;
(c) second printing means for printing a second side of the web, the first and the second printing means being spaced from, and in register with, each other in a prescribed direction; and
(d) guide means for guiding the web past the first and the second printing means one after the other;
(e) whereby the web can have its opposite sides printed while traveling along a path that is contained in a plane extending in the prescribed direction.

2. The double-side printing apparatus of claim 1 wherein the guide means are arranged to guide the web past the first printing means in a second direction, different from the first recited direction, and then past the second printing means in a third direction which is opposite to the second direction.

3. The double-side printing apparatus of claim 1 further comprising:
(a) a first drier disposed between the first and the second printing means for drying the printings made on the first side of the web by the first printing means; and
(b) a second drier disposed downstream, with respect to the traveling direction of the web through the apparatus, of the second printing means for drying the printings made on the second side of the web by the second printing means.

4. The double-sided printing apparatus of claim 3 wherein the first and the second drier are each in the form of a drum forming a part of the guide means.

5. A double-side printing apparatus capable of printing both sides of a web of paper or like printable material, comprising:
(a) infeed means for supplying a web of paper or the like to be printed;
(b) delivery means for receiving the web after the same has been printed;
(c) first printing means for printing a first side of the web;
(d) second printing means for printing a second side of the web, the first and the second printing means being spaced from each other in a plane containing the infeed means and the delivery means; and
(e) a set of guide rollers for guiding the web past the first printing means in a first direction and then past the second printing means in a second direction which is opposite to the first direction;
(f) whereby the web can have its opposite sides printed while traveling in the plane containing the infeed means and the delivery means and the first and the second printing means.

6. The double-side printing apparatus of claim 5 further comprising:
(a) a first drier disposed between the first and the second printing means for drying the printings made on the first side of the web by the first printing means; and
(b) a second drier disposed between the second printing means and the delivery means for drying the printings made on the second side of the web by the second printing means.

7. A double-side ink-jet printer apparatus capable of printing both sides of a web of paper or like printable material, comprising:
(a) infeed means for supplying a web of paper or the like to be printed;
(b) a first set of ink-jet printers in alignment for printing a first side of the web;
(c) a second set of ink-jet printers in alignment for printing a second side of the web, the first and the second set of ink-jet printers being spaced from each other in a plane containing the infeed means; and
(d) guide means for guiding the web past the first set of ink-jet printers in a first direction and then past the second set of ink-jet printers in a second direction which is opposite to the first direction;
(e) whereby the web can have its opposite sides printed while traveling in the plane containing the infeed means and the first and the second set of ink-jet printers.

8. The double-side ink-jet printer apparatus of claim wherein the first and the second set of ink-jet printers are parallel to each other, and wherein the individual ink-jet inters are all oriented in the same direction.
